(19) United States
(12) Patent Application Publication
(10) Pub. No.: US 2019/0385251 A1
(43) Pub. Date: Dec. 19, 2019

(54) COGNITIVE ALTERNATE VACATION BOOKING

(71) Applicant: International Business Machines Corporation, Armonk, NY (US)

(72) Inventors: John S. Werner, Fishkill, NY (US); Ali Y. Duale, Poughkeepsie, NY (US); Arkadiy O. Tsfasman, Wappingers Falls, NY (US); Shailesh R. Gami, Poughkeepsie, NY (US); Louis P. Gomes, Poughkeepsie, NY (US)

(21) Appl. No.: 16/008,274

(22) Filed: Jun. 14, 2018

(51) Int. Cl. G06Q 50/14; G06Q 10/02; G06F 17/30

(52) U.S. Cl. CPC G06Q 50/14; G06Q 10/02; G06Q 50/01; G06F 17/3087; G06F 17/30867

(57) ABSTRACT

Aspects of the invention include tracking actions performed by a via a user device, and detecting that the user has made reservations for at least a subset of a first vacation at a first vacation location. Based at least in part on the tracking and detecting, attractions and events related to the first vacation location are extracted. Conditions at the first vacation location and at the extracted attractions and events are monitored. The user is notified of any conditions that may negatively impact the first vacation. In response to a request from the user, an alternative vacation is offered to the user with attractions and events that are similar to the extracted attractions and events. The alternate vacation is at an alternate vacation location different than the first vacation location.

### BACKGROUND

Embodiments of the present invention relate in general to using computers for booking vacations, and more specifically to using cognitive computing for suggesting and booking alternative vacations.

People often spend a lot of time and money planning out vacations well in advance of actually going on the trip. There are currently various online avenues for providing assistance in planning and booking vacations. Contemporary computerized vacation booking systems allow travelers to view prices and schedules for transportation such as airplanes, buses, trains, and rental cars, as well as to reserve or buy a ticket for such transportation when a match is found. Vacation booking systems can also allow users to view information about a vacation destination and facilitate making hotel reservations, making restaurant reservations, purchasing tickets for tourist attractions, etc. When the time comes to go on the trip, conditions out of the user's control (e.g., weather, natural disaster, protest, closing or renovations on tourist attraction) may negatively impact the vacation experience. Users have the option of purchasing insurance for their trip, but that might leave them scrambling to make alternate plans at the last minute resulting in a vacation that is not as enjoyable as the originally planned trip, or they may decide not to go on a vacation at all.

Accordingly, while vacation booking systems are suitable for their intended purposes, what is needed is a vacation booking system having certain features of embodiments of the present invention.

### SUMMARY

Embodiments of the present invention include methods, systems, and computer program products for using cognitive computing for suggesting and booking alternative vacations. A non-limiting example method includes tracking actions performed by a user via a user device, and detecting that the user has made reservations for at least a subset of a first vacation at a first vacation location. Based at least in part on the tracking and detecting, attractions and events related to the first vacation location are extracted. Conditions at the first vacation location and at the extracted attractions and events are monitored. The user is notified of any conditions that may negatively impact the first vacation. In response to a request from the user, an alternative vacation is offered to the user with attractions and events that are similar to the extracted attractions and events. The alternate vacation is at an alternate vacation location different than the first vacation location.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a system for performing cognitive computing to suggest and book alternative vacations in accordance with one or more embodiments of the present invention;

FIG. 2 is a flow diagram of a process for using cognitive computing for suggesting and booking alternative vacations in accordance with one or more embodiments of the present invention;

FIG. 3 is a flow diagram of a process for extracting vacation bookings and corresponding attractions, events and/or locations in accordance with one or more embodiments of the present invention;

FIG. 4 is a flow diagram of a process for finding an alternate vacation in accordance with one or more embodiments of the present invention;

FIG. 5 depicts a graphical user interface of a user device in accordance with one or more embodiments of the present invention;

FIG. 6 depicts a cloud computing environment according to one or more embodiments of the present invention;

FIG. 7 depicts abstraction model layers according to one or more embodiments of the present invention; and

FIG. 8 is a block diagram of a computer system for implementing some or all aspects of performing cognitive computing to suggest and book alternative vacations in accordance with one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

One or more embodiments of the present invention provide cognitive alternate vacation booking that, in the event of determining unwanted conditions at a destination location in a user's original vacation plans, offers an alternative trip to a different destination location that is likely to appeal to the user. The alternative trip can be selected by analyzing the user's interactions on a computer such as, but not limited to: search history, communications, and bookings for their selected vacation. The analyzing can include extracting attractions, events, locations, etc. that the user researched and was likely to visit while on vacation. As used herein the term “attraction” refers to any place or activity that a person visits on a vacation such as, but not limited to: a theme park, a museum, a historical landmark, a restaurant, a beach, a scenic area, a store, shopping, scuba diving, snowboarding, skiing, and/or hiking. As used herein the term “event” refers to a planned happening such as, but not limited to: a show, a concert, a festival, a convention, and/or a sporting event. As used herein the term “location” refers a place such as, but not limited to: a town, a resort area, or another geographic location. One or more embodiments of the present invention monitor the extracted attractions, events, and/or locations in the days and weeks prior to the vacation to notify the user of conditions that might negatively impact their vacation. If the user decides to cancel their selected vacation, one or more embodiments of the present invention search for alternate attractions, events, and/or locations that most closely match the selected vacation, are within similar price range, and are still available for booking.

One or more embodiments of the present invention allow a user to easily switch to an alternative vacation. One or more embodiments can be utilized by travel websites, airlines, hotel chains, etc. to allow them to better satisfy their customers and to avoid having to give out refunds. The customers can be provided with a simple way to change their original vacation plans when conditions that impact the original vacation plans occur, while still having the opportunity to enjoy similar attractions, events and/or locations as those planned for original vacation.

Contemporary methods of vacation planning typically include a customer booking a vacation; the customer finding out on their own (or not finding out at all) about a condition that may impact their booked vacation by searching websites via a computer network (e.g., the Internet), viewing news websites and/or other forms of communication; the customer looking for alternate vacation locations by searching travel websites via a computer network; and the customer canceling the booked vacation and booking an alternative vacation.

Vacation planning using one or more embodiments of the present invention is contrasted with contemporary methods of vacation planning. In accordance with one or more embodiments of the present invention, instead of each customer individually monitoring their own booked vacation locations, attractions, and events for a condition(s) that may impact their planned vacation, a computer program monitors vacation locations, attractions, and events that are associated with the customer's planned vacation and then sends a notification to the customer if an adverse condition is detected. The computer program performing the monitoring can be remote from a processor (e.g., laptop, smartphone) utilized by the customer and can provide alerts via a network connection. One or more embodiments of the present invention can also lead to a decreased use of local computer resources, such as network and processor resources because the customer is alerted of any possible conditions that may impact the location without the customer having to check periodically via their own processing device connected to a network.

In one or more embodiments of the present invention, the remote computer program monitors a vacation location for more than one customer (tens, hundreds, thousands, etc.) and alerts all of them when a condition occurs that may impact a planned vacation at the vacation location. This can result in a reduction in processor requirements when compared to the computer program monitoring a location individually for each customer. A similar reduction in processor requirements can also be realized by having a computer program monitoring a vacation attraction and/or a vacation event for more than one customer.

In one or more embodiments of the present invention a computer program executing on a computer remote from a processor utilized by the customer, upon detecting a condition that may impact a booked vacation plan, sends suggested alternate vacation locations, attractions, and/or events to the customer. This can lead to a decrease in the use of local computer resources, such as network and processor resources because the customer is no longer using network and processor resources while searching for alternatives, but is instead being presented with alternate vacation plans.

In one more embodiments of the present invention, the remote computer program provides alternate vacation location suggestions for more than one customer (tens, hundreds, thousands, etc.) by grouping customers together with similar vacation plans and interests. This can result in a reduction in processor and network requirements when compared to the computer program determining alternate vacation locations individually for each customer.

In accordance with one or more embodiments, historic data can be used to learn how often maintenance occurs, what kind of past weather events have closed certain attractions, if the area is prone to riots (e.g., very political), etc. This kind of information can be used to predict something that may impact the booked vacation but that hasn't yet occurred such as, but not limited to, events such as: maintenance in a theme park is always performed once a year in October and rides are closed; a hurricane a hundred miles away typically increases waves at a beach so the beach attractions such as snorkeling are likely to close; voting on a bill may cause riots if it supports the agenda of a particular political party and the majority of the town belongs to another political party; and/or riots have occurred after a big sports victory or loss. In one or more embodiments, cognitive learning can be used to predict these events before something actually closes in order to inform the user of a possibility of something that may impact their trip sooner than if a human were just monitoring the events/locations that they plan to visit.

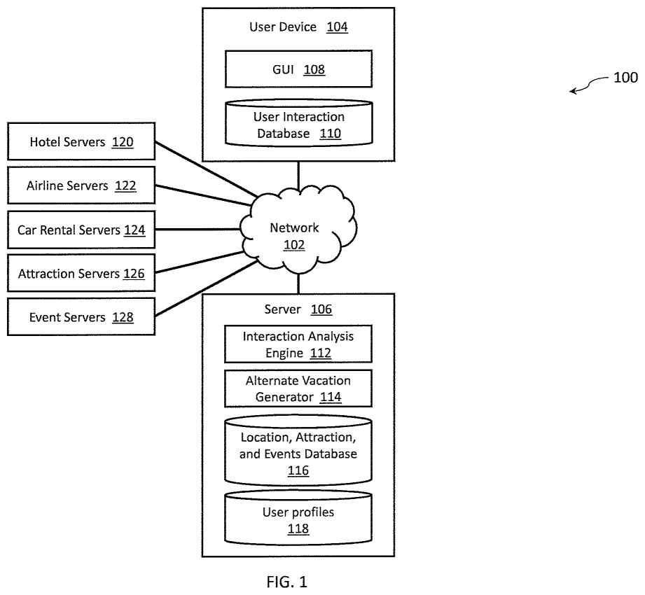

Turning now to FIG. 1, a system 100 for performing cognitive computing to suggest and book alternative vacations is generally shown in accordance with one or more embodiments of the present invention. As shown in the embodiment of FIG. 1, a user device 104 interacts over a network 102 with an application server 106, as well as additional servers such as, but not limited to: hotel servers 120, airline servers 122, car rental servers 124, attraction servers 126, and event servers 128. In one or more embodiments, the user device 104 includes a graphical user interface 108 to interface with the application server 106 as well as a user interaction database 110 that tracks search history and communication with other users, as well as any other interactions that may include, but are not limited to: the user's likes, dislikes, interests, and reasons for wanting to visit a particular vacation spot.

The application server 106 shown in FIG. 1 includes an interaction analysis engine 112, an alternate vacation generator 114, a location, attraction, and event database 116, and user profiles database 118. The interaction analysis engine 112 can parse through and analyze contents of the user interaction database 110 and may use artificial intelligence (AI) tools and/or cognitive computing tools such as Watson™ from IBM to perform the analysis. One or more embodiments of the interaction analysis engine 112 can utilize application programming interfaces (APIs) such as, but not limited to a language understanding API, a natural language classifier API, a speech to text API, and/or a visual recognition API. The results of the analysis performed by the interaction analysis engine 112 can be stored in the user profiles database 118.

One or more embodiments of the alternate vacation generator 114 can be used to access the location, attraction, and events database 116 in conjunction with the analysis data from the interaction analysis engine 112 to generate alternate vacation suggestions that are most similar to the originally booked vacation. In one or more embodiments, the alternate vacation suggestions are in the same price range of the originally booked vacation such that the user can easily switch their vacation in the event of conditions negatively affecting the desire to go to the first vacation location. In some embodiments, the alternate vacation suggestion may include airline tickets, rental car, hotel room, etc. from the same chains as the originally booked vacation such that business still goes to the same merchants. If the same merchant cannot fulfill a portion of the reservation, the merchant may recommend another merchant to fill that potion of the reservation.

As shown in FIG. 1, additional servers such as, but not limited to hotel servers 120, airline servers 122, car rental servers 124, attraction servers 126, and/or event servers 128 can be utilized by the interaction analysis engine 112 and/or the alternate vacation generator 114. In addition, the additional servers can be accessed for booking hotels, flights, car rentals, and/or for purchasing tickets for attractions and events. In an embodiment, API's may be utilized that allow the server 106 to interact with the additional servers.

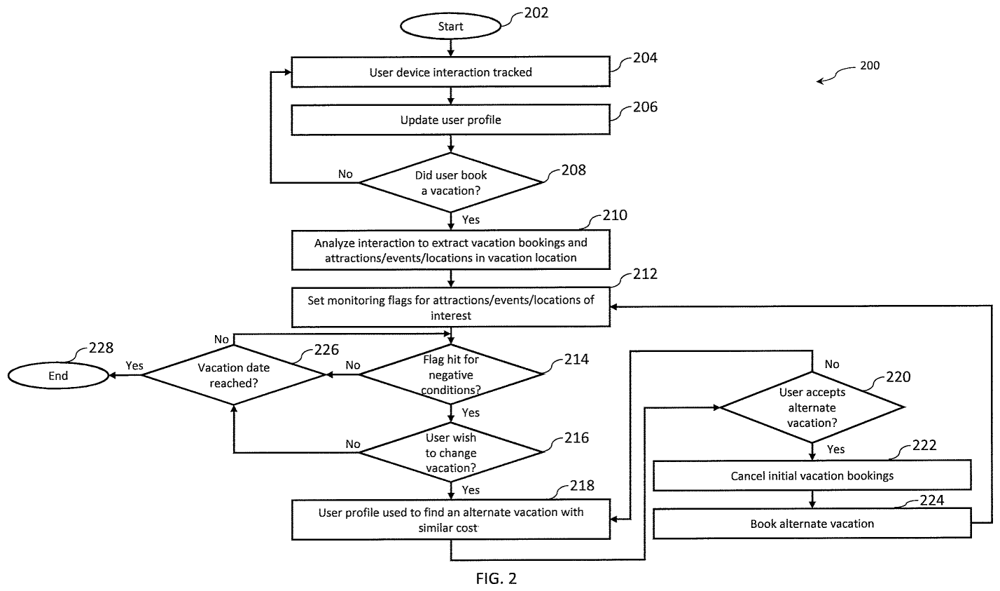

Turning now to FIG. 2, a flow diagram 200 of a process for using cognitive computing for suggesting and booking alternative vacations is generally shown in accordance with one or more embodiments of the present invention. The processing shown in FIG. 2 can be performed for example, by all or a portion of the interaction analysis engine 112 of FIG. 1 and the alternate vacation generator 114 of FIG. 1 executing on the server 106 of FIG. 1. The process starts at block 202, and at block 204 a user's interaction with their user device, such as user device 104 of FIG. 1, is tracked. In one or more embodiments, the interaction includes, but is not limited to search history, conversations through social media, conversations through text, conversations through electronic-mail (e-mail), and/or voice conversations.

At block 206, a user profile for the user is updated and stored for example, in user profiles database 118 of FIG. 1. The user profile can be built based on the user's interaction to determine likes, interests, location of family and friends, prior vacation information, locations that the user has researched and/or talked about with others, etc. In one or more embodiments, the data is parsed using a tool such as Watson. At block 208 it is determined whether the user has booked a vacation. If the user has not booked a vacation, then processing continues at block 204 with monitoring the user's interaction with the user device and updating the user profile at block 206. In one or more embodiments, a user may have more than one device (e.g., a telephone and a laptop computer) linked through a cloud or registered with the system that are used to build the user profile.

This loop of monitoring, updating, and checking at blocks 204-208 continues until it is detected, at block 208, that the user has booked at least part of a vacation. In some embodiments, the monitoring at block 204 and updating of the user profile at block 206 may continue after the user has booked at least a portion of a vacation at block 208.

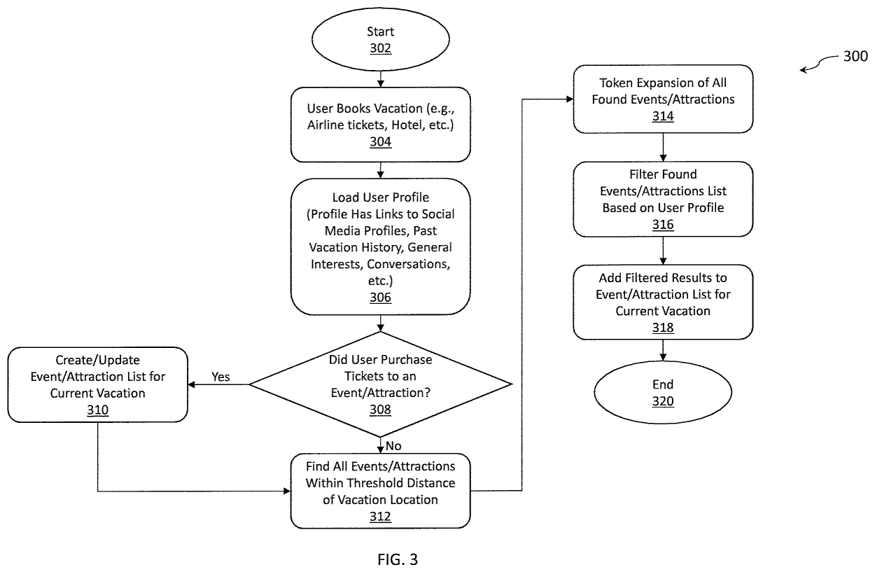

Processing continues at block 210 when it is detected at block 208 that the user has booked, or made reservations for, at least a portion of a vacation. At block 210, analysis is performed on interactions of the user to extract information related to the vacation. Interactions can include the booking of a flight, hotel, car rental, and/or tickets to an out of town event, all of which may indicate when and where a user is taking a vacation as well as planned activities. In an embodiment, information about upcoming vacations can be discovered through the same type of analysis used to build a user profile, such as those stored in the user profiles database 118 of FIG. 1. This can include, but is not limited to monitoring user purchases within websites or applications visited, emailed receipts, text message confirmations, and analysis of telephone conversations (e.g., with hotel chains, car rental companies, etc.). The analysis at block 210 can also include determining likely areas that the user intends to visit and whether or not the user has purchased tickets for a particular attraction. A user may not purchase a ticket for an attraction that they plan on visiting either because tickets are not sold (e.g., a restaurant that does not take reservations) or because the user may intend to purchase tickets in person (e.g., based on weather conditions). The analysis at block 210 can also include determining if the user intends to visit family and/or friends during the vacation. An embodiment of the interaction analysis and the extraction of vacation bookings and attractions, events, and/or locations of interest in the vacation location performed in block 210 is described below in reference to FIG. 3.

Once the attractions, events and/or locations of interest are determined at block 210, processing continues at block 212 where monitoring flags are set for the determined attractions, events, and/or locations of interest. Monitoring flags can also be set for flights and any other bookings or likely bookings. In embodiment, the monitoring at block 212 is performed by software such as alternate vacation generator 114 of FIG. 1 executing on server 106 of FIG. 1. The monitoring can include looking for any negative condition that may cause the user to have a sub-optimal experience while on vacation such as, but not limited to: bad weather predictions; injury or illness (e.g., if the user planned to go snowboarding but broke their leg, they may still be able to enjoy a vacation somewhere else); natural disasters (e.g., hurricane or earthquake that struck the area and caused damage); attractions or events that are closed (e.g., due to maintenance, upgrades, failed business, vandalism, etc.); riots, terrorist attacks, mandatory evacuations, protests, etc. in or near the vacation location; and/or friend or family member being visited has an unexpected event arise. The monitoring may be done via Watson API's that parse the text (or voice translated to text) from sources such as public information posted on additional servers 120 122 124 126 128, news programs and websites, social media, etc.

At block 214 it is determined if any monitoring flag indicates a negative condition. If none of the monitoring flags indicate a negative condition, then processing continues at block 226 where it is determined whether the vacation date has been reached. If it is determined at block 226 that the vacation date has been reached, then the monitoring ends at block 228. If it is determined at block 226 that the vacation date (e.g., the start date of the vacation, the end date of the vacation) has not been reached, then processing continues at block 214 with determining whether any of the monitoring flags indicates a negative condition.

If it is determined at block 214 that a monitoring flag indicates a negative condition, then block 216 is performed to determine whether the user would like to change their vacation due to the negative condition. In an embodiment, the determination is made by sending the user a notification describing the negative condition (e.g., via a push notification, an email, a text message, etc.) and asking them if they would like to make a change in their vacation plans. If the user indicates that they would not like to change their vacation plans as determined at block 216, then processing continues at block 226 with determining whether the vacation date has been reached.

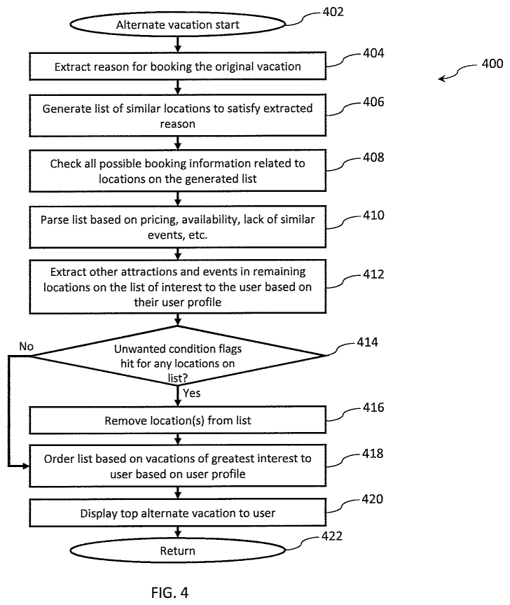

If the user indicates that they would like to change their vacation plans as determined at block 216, then processing continues at block 218 where a user profile of the user is analyzed to find an alternate vacation at a similar cost. The analysis can include analyzing the original vacation plans of the user along with the user profile to determine similar vacation locations with similar attractions and events of interest to the user that can be booked at a similar price. An embodiment of the analysis performed at block 216 is described below in reference to FIG. 4.

An alternate vacation plan is presented to the user (e.g., in an online manner, or via a push notification, an email, a text message, etc.) and at block 220 it is determined whether the user accepts the alternate vacation plan. If the user accepts the alternate vacation plan, then processing continues at block 222 with canceling the original vacation bookings and at block 224 with booking the alternate vacation plan. In accordance with one or more embodiments of the present invention, blocks 222 and/or block 224 require the user to provide a password or other security credential to verity that they have authority to cancel and book vacation for the user. Processing continues at block 212 with setting up monitoring flags for the alternate vacation plan.

If the user does not accept the alternate vacation plan, as determined at block 220, then processing can continue at block 218 with finding another alternate vacation plan to present to the user. As shown in FIG. 2, this loop can continue until the user accepts an alternate vacation plan. In an alternate embodiment, after a specified number of attempts (e.g., one, five, ten, twenty) at finding and presenting alternative vacation plans, processing continues at block 214 and the user is notified on a periodic basis (e.g., weekly for those already set and within minutes/hours for any new flags) of any flags that indicate negative conditions and given the option of selecting an alternative vacation. In another alternate embodiment, a list of alternate vacation may be presented to the user (e.g., top three closest matches, top five closest matches, etc.) allowing the user to pick the most appealing rather than seeing one at a time. In yet another embodiment, the list may be presented to the user at the time of booking their original vacation such that the user's desired alternate choice is known earlier and will book the alternate vacation if negative conditions are not detected at said location.

Turning now to FIG. 3, a flow diagram 300 of a process for extracting vacation bookings and corresponding attractions, events, and/or locations is generally shown in accordance with one or more embodiments of the present invention. The processing shown in FIG. 3 can be performed for example, by all or a portion of the interaction analysis engine 112 of FIG. 1 executing on the server 106 of FIG. 1. The processing shown in FIG. 3 is an example embodiment of the processing performed in block 210 of FIG. 2. The learning process to find events, attractions, and/or locations of interest to the user begins at block 302 and at block 304 it is determined that the user has booked a vacation based, for example, on detecting that the user has purchased airline tickets, made hotel reservations, purchased tickets to an attraction or event, etc. At block 304, the user profile, stored for example in the user profile database 118 of FIG. 1, is accessed. In an embodiment, the user profile is linked to multiple forms of communication of the user. As used herein, the term “linked” refers to users giving permission to access email, text, phone conversations, and social media profiles, etc. The interaction analysis engine can parse through data such as, but not limited to the linked social media profiles, text conversations, past vacation history, and general interests using, for example, natural language processing (NLP) to create a list of interests of the user.

At block 308, it is determined whether the user has purchased tickets to a specific event or attraction (e.g., a theme park, a concert) as part of the booked vacation. If it is determined at block 308 that the user has purchased tickets to a specific event(s) and/or attraction(s), then processing continues at block 310 with the event(s) and/or attraction(s) being added to a list of things to monitor because it is known that the user plans to go to the event(s) and/or attraction(s). Once the list is updated, processing continues at block 312. If it is determined at block 308 that the user has not purchased tickets for specific events or attractions, then processing continues at block 312.

Referring to FIG. 3, at block 312 all events and attractions within a threshold distance of the vacation location are found by performing a search. In an embodiment the threshold distance can vary from a few miles to a hundred or more miles based on factors such as but not limited to a density of events and attractions near the vacation location, a travel time to the vacation location and/or whether the user has rented a car for the vacation. The search can include searching one or more servers such as attraction servers 126 and event servers 128 of FIG. 1 for information about events and attractions at the vacation location during the time that the user plans to be there. At block 314 a token, or keyword, expansion is performed on the events and attractions found in block 312. For example, if the beach is an attraction that is found, then it can be expanded to include keywords such as beach, surfing, snorkeling, scuba diving, etc. The expansion can be performed based on analysis of data from various sources such as, but not limited to user reviews (e.g., from websites such as Yelp), webpages, and/or online brochures.

At block 316, the expanded list of keywords is filtered based on the list of interests in the user profile, and at block 318, the filtered results are added to the events and/or attraction list for the current, or booked, vacation. The contents of the list are monitored for negative conditions using a method such as that described in reference to FIG. 2. Processing is completed at block 320.

Turning now to FIG. 4, a flow diagram 400 of a process for finding an alternate vacation is generally shown in accordance with one or more embodiments of the present invention. The processing shown in FIG. 4 can be performed for example, by all or a portion of the alternate vacation generator 114 of FIG. 1 executing on the server 106 of FIG. 1. The processing shown in FIG. 4 is an example embodiment of the processing performed in block 218 of FIG. 2. The process of finding an alternate vacation location starts at block 402. In order to determine an alternate vacation location, block 404 is performed to extract the main reason for the original, or first, vacation that was booked. The main reason can include, but is not limited to relaxing on a beach, traveling by cruise ship, skiing/snowboarding, golfing, shopping, sightseeing, and/or visiting family. In an embodiment, the user is asked to verify and/or to supplement the main reason(s) for the vacation.

At block 406 of FIG. 4, a list of locations where the user can go that can achieve as many of the reasons for the first vacation is generated. For example, if the user was planning to go to Colorado to go snowboarding, alternate ski resort locations may be generated in the list such as, but not limited to Utah, Vermont, and/or Switzerland. In another example, if the user was planning to relax on the beach in California, the list generated at block 406 may include alternate beach resort locations such as, but not limited to Florida, Hawaii, and/or the Bahamas. In another example, if the user was planning on visiting family in Chicago, the list generated at block 406 may include a list of alternate locations of different family members that were discovered via the profile analysis or a location that is nearby (e.g., within one to two hours) of the original vacation location to visit the same family members. In another example, if the user was planning to go to a country music festival in Texas, the list generated at block 406 may include locations of other country music festivals or shows.

Once a list of alternate vacation locations is generated at block 406, block 408 is performed to check possible booking information related to the alternate vacation locations. The booking information can include flight information, hotel availability, car rental services, and similar events and/or attractions of the original vacation that was booked. At block 410, the list generated at block 406 is parsed based on pricing availability, lack of similar events and/or attractions, etc. as determined at block 408. For example, vacation locations that are not within a programmable threshold price range of the original vacation (e.g., more than ten or twenty percent higher in price), vacation locations that do not have similar events and/or attractions, and/or vacation locations that do not have hotels rooms available can be eliminated from the list generated at block 406. In an embodiment, travel time is also taken into account. For example, if the first vacation that was booked involved the user traveling to a vacation location that is three hours from the user's home, then suggestions for any vacation locations more than six hours from the user's home can be eliminated from the list. In an embodiment, the ratio of the travel time and other parameters used to measure similarity between the original vacation location and an alternate vacation location are programmable and can vary based on user.

At block 412 of FIG. 4, additional events and/or attractions from alternate vacation locations still on the list after the parsing at block 410 are located based on contents of the user's profile. In this manner, other events and/or attractions that the user may find of interest at the alternate vacation location can also be presented to the user. At block 414, it is determined whether any unwanted condition flags are set for any of the vacation locations of on the list. Any alternate vacation locations having unwanted condition flags set are removed from the list at block 416. In an embodiment, based on user input previously, vacation locations visited by the user are removed from the list (e.g., for variety) as well as locations that the user has blacklisted (e.g., the user does not want to go to a particular country or region or does not want to leave the country). Processing continues at block 418 with ordering the list of alternate vacation locations based on vacation locations appearing to have the greatest interest to the user, based for example on the user's profile.

In accordance with one or more embodiments, a user's interests can be ranked by how often the user talks about them or how often the user visits web pages having to do with an interest. For example, if a user constantly visits scuba diving web pages and forums to check out new equipment, techniques, etc., it can be determined by the system that scuba diving is a much higher interest (e.g., a higher priority) for the user than another interest such as shopping, so even though both were planned for the original location, alternate vacation suggestions that have better scuba diving reviews may be determined to have the greatest interest to the user. In addition, places that the user specifically looked at or discussed in forums/web pages in the past may also be determined to have a greater interest to the user. In an embodiment, it may be determined that the user may also have some interest in surfing so even though they weren't planning on doing that at the original vacation because the beach was not known to have good waves, the alternate vacation that is second best for scuba diving may be suggested because it also has surfing rather that an alternate vacation that has the best scuba diving, but not much else that is of interest to the user.

In accordance with one or more embodiments location of friends and/or family on social media may also impact a ranking of a user's interest. If other friends live near one of the alternate vacation suggestions, or are also planning a trip to one of the alternate vacation locations, that may affect the weight of the user's interest in the alternate vacation.

At block 420, the top alternate vacations are displayed to the user. The number displayed can be customized to include the top one or the top three or the top five or to any other number. At block 422, the process is completed,

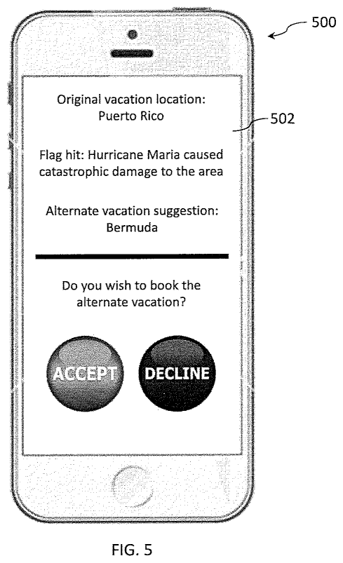

Turning now to FIG. 5, a graphical user interface (GUI) 502 of a mobile device 500 is generally shown in accordance with one or more embodiments of the present invention. In an embodiment, the GUI 502 shown in FIG. 5 is output by block 218 of FIG. 2 or block 420 of FIG. 4. If the user does not accept the alternate vacation suggestion as presented in the GUI 502 of FIG. 5, then block 218 can be repeated to display the next alternate vacation location on the ordered list of alternate vacation locations generated, for example by the processing of FIG. 4. Once the user accepts the alternate vacation location, blocks 222 and 224 of FIG. 2 are performed to cancel the original vacation plans and to book the alternate vacation plans with no further interaction by the user. As described previously with respect to FIG. 2, the system continues (e.g., at block 212 of FIG. 2) to monitor for flags on the current vacation (whether that be the original vacation plans or an alternate vacation selection) until the vacation date is reached.

In an embodiment, the system runs on a travel website/application such as, but not limited to those provided by Priceline and TripAdvisor, to provide full vacation plans. In addition, or alternatively, an embodiment of the system is executed by individual business such as, but not limited to, airlines or hotels that have incentive to help a user find an alternate location to travel to using their business so that they get the full amount that was going to be paid by the user for the original booking. In an embodiment, a fee is charged to use the system (e.g., similar to purchasing insurance for a vacation). In another embodiment, no fee is charged and the system is offered as a free incentive to build a larger customer base.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

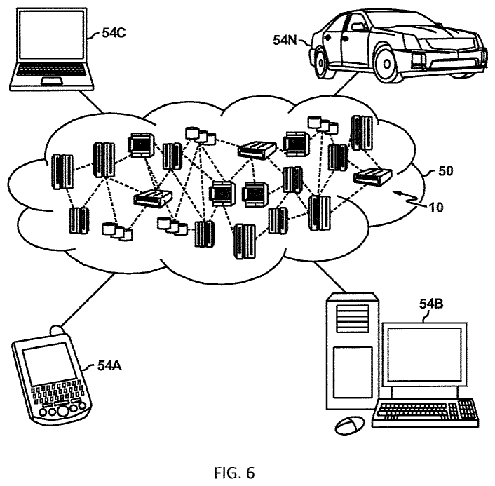

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

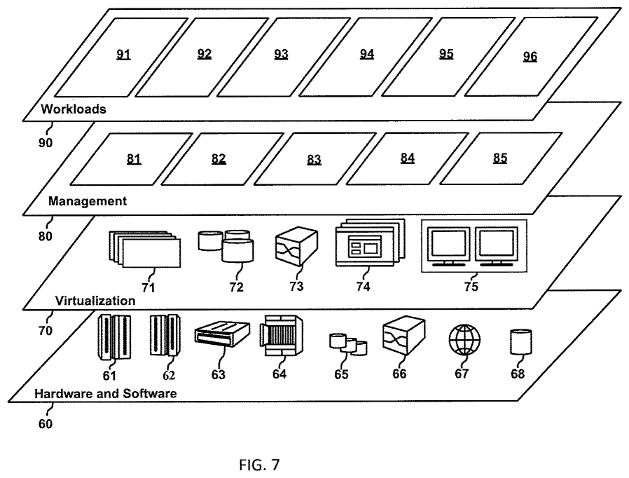

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and mobile desktop 96.

In accordance with one or more embodiments of the present invention, system shown in FIG. 1 is located in the cloud computing environment of FIG. 7 where all or a subset of the processing shown in FIGS. 2-4 is performed.

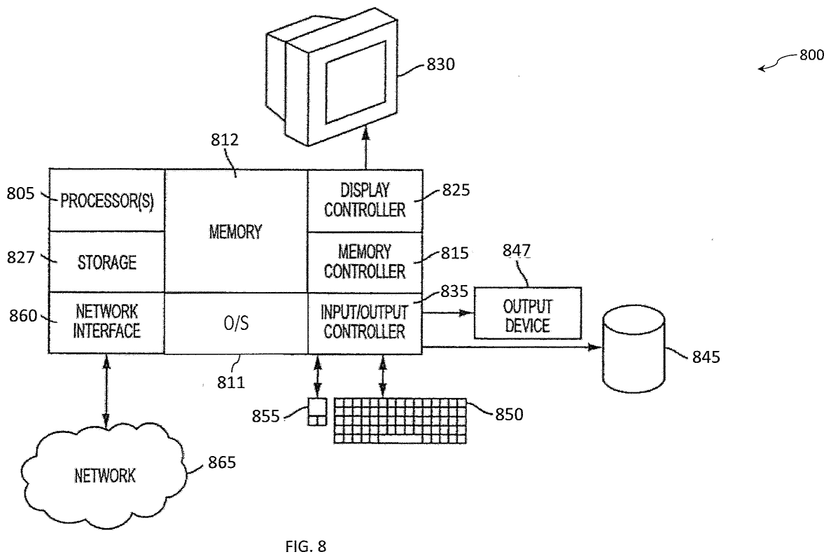

Turning now to FIG. 8, a block diagram of a computer system 800 for implementing some or all aspects of providing cognitive alternative vacation booking is generally shown in accordance with one or more embodiments of the present invention. The processing described herein may be implemented in hardware, software (e.g., firmware), or a combination thereof. In an exemplary embodiment, the methods described may be implemented, at least in part, in hardware and may be part of the microprocessor of a special or general-purpose computer system 800, such as a mobile device, personal computer, workstation, minicomputer, or mainframe computer. In an embodiment the server 106 and/or the user device 104 of FIG. 1 is implemented by the computer system 800 shown in FIG. 8.

In an exemplary embodiment, as shown in FIG. 8, the computer system 800 includes a processor 805, memory 812 coupled to a memory controller 815, and one or more input devices 845 and/or output devices 847, such as peripherals, that are communicatively coupled via a local I/O controller 835. These devices 847 and 845 may include, for example, a printer, a scanner, a microphone, and the like. A conventional keyboard 850 and mouse 855 may be coupled to the I/O controller 835. The I/O controller 835 may be, for example, one or more buses or other wired or wireless connections, as are known in the art. The I/O controller 835 may have additional elements, which are omitted for simplicity, such as controllers, buffers (caches), drivers, repeaters, and receivers, to enable communications.

The I/O devices 847, 845 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 805 is a hardware device for executing hardware instructions or software, particularly those stored in memory 812. The processor 805 may be a custom made or commercially available processor, a central processing unit (CPU), an auxiliary processor among several processors associated with the computer system 800, a semiconductor based microprocessor (in the form of a microchip or chip set), a microprocessor, or other device for executing instructions. The processor 805 can include a cache such as, but not limited to, an instruction cache to speed up executable instruction fetch, a data cache to speed up data fetch and store, and a translation look-aside buffer (TLB) used to speed up virtual-to-physical address translation for both executable instructions and data. The cache may be organized as a hierarchy of more cache levels (L1, L2,etc.).

The memory 812 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 812 may incorporate electronic, magnetic, optical, or other types of storage media. Note that the memory 812 may have a distributed architecture, where various components are situated remote from one another but may be accessed by the processor 805.

The instructions in memory 812 may include one or more separate programs, each of which comprises an ordered listing of executable instructions for implementing logical functions. In the example of FIG. 8, the instructions in the memory 812 include a suitable operating system (OS) 811. The operating system 811 essentially may control the execution of other computer programs and provides scheduling, input-output control, file and data management, memory management, and communication control and related services.

Additional data, including, for example, instructions for the processor 805 or other retrievable information, may be stored in storage 827, which may be a storage device such as a hard disk drive or solid state drive. The stored instructions in memory 812 or in storage 827 may include those enabling the processor to execute one or more aspects of the dispatch systems and methods of this disclosure.

The computer system 800 may further include a display controller 825 coupled to a display 830. In an exemplary embodiment, the computer system 800 may further include a network interface 860 for coupling to a network 865. The network 865 may be an IP-based network for communication between the computer system 800 and an external server, client and the like via a broadband connection. The network 865 transmits and receives data between the computer system 800 and external systems. In an exemplary embodiment, the network 865 may be a managed IP network administered by a service provider. The network 865 may be implemented in a wireless fashion, e.g., using wireless protocols and technologies, such as WiFi, WiMax, etc. The network 865 may also be a packet-switched network such as a local area network, wide area network, metropolitan area network, the Internet, or other similar type of network environment. The network 865 may be a fixed wireless network, a wireless local area network (LAN), a wireless wide area network (WAN) a personal area network (PAN), a virtual private network (VPN), intranet or other suitable network system and may include equipment for receiving and transmitting signals.

Systems and methods for providing cognitive alternate vacation booking can be embodied, in whole or in part, in computer program products or in computer systems 800, such as that illustrated in FIG. 8.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
tracking actions performed by a user via a user device;
detecting that the user has made reservations for at least a subset of a first vacation at a first vacation location;
based at least in part on the tracking and detecting, extracting attractions and events related to the first vacation location;
monitoring conditions at the first vacation location and at the extracted attractions and events;
notifying the user of any conditions that may negatively impact the first vacation; and
in response to a request from the user, offering an alternative vacation to the user with attractions and events that are similar to the extracted attractions and events, the alternate vacation at an alternate vacation location different than the first vacation location.

2. The method of claim 1, wherein the tracking comprises analyzing a search history of the user, a social media interaction of the user, a text conversation of the user, an email interaction of the user, or a voice conversation of the user.

3. The method of claim 1, wherein the user does not have a reservation for at least one of the extracted attractions and events related to the first vacation location.

4. The method of claim 1, wherein the alternate vacation location is a location that was found by the tracking in a search history of the user.

5. The method of claim 1, wherein a price of the alternate vacation is within a threshold price range of the first vacation.

6. The method of claim 1, further comprising generating a user profile of the user based on the tracking, wherein the user profile is used to determine additional attractions and events at the alternate vacation that may be of interest to the user that are not similar to attractions and events related to the first vacation.

7. The method of claim 1, wherein multiple alternative vacations are iterated through before one is accepted by the user.

8. The method of claim 1, further comprising:
accepting, by the user, the alternate vacation;
based at least in part on the accepting, canceling the first vacation and making reservations for the alternate vacation.

9. The method of claim 1, wherein the monitoring comprises accessing historic data and a condition that may negatively impact the first vacation is a predicted condition determined based at least in part on the historic data.

10. A system comprising:
a memory having computer readable instructions; and
one or more processors for executing the computer readable instructions, the computer readable instructions controlling the one or more processors to perform operations comprising:
tracking actions performed by a user via a user device;
detecting that the user has made reservations for at least a subset of a first vacation at a first vacation location;
based at least in part on the tracking and detecting, extracting attractions and events related to the first vacation location;
monitoring conditions at the first vacation location and at the extracted attractions and events;
notifying the user of any conditions that may negatively impact the first vacation; and
in response to a request from the user, offering an alternative vacation to the user with attractions and events that are similar to the extracted attractions and events, the alternate vacation at an alternate vacation location different than the first vacation location.

11. The system of claim 10, wherein the tracking comprises analyzing a search history of the user, a social media interaction of the user, a text conversation of the user, an email interaction of the user, or a voice conversation of the user.

12. The system of claim 10, wherein the user does not have a reservation for at least one of the extracted attractions and events related to the first vacation location.

13. The system of claim 10, wherein the alternate vacation location is a location that was found by the tracking in a search history of the user.

14. The system of claim 10, wherein a price of the alternate vacation is within a threshold price range of the first vacation.

15. The system of claim 10, wherein the operations further comprise generating a user profile of the user based on the tracking, wherein the user profile is used to determine additional attractions and events at the alternate vacation that may be of interest to the user that are not similar to attractions and events related to the first vacation.

16. The system of claim 10, wherein multiple alternative vacations are iterated through before one is accepted by the user.

17. The system of claim 10, wherein the operations further comprise:
accepting, by the user, the alternate vacation;
based at least in part on the accepting, canceling the first vacation and making reservations for the alternate vacation.

18. A computer program product comprising a computer readable storage medium having program instructions embodied therewith, the program instructions executable by a processor to cause the processor to perform operations comprising:
tracking actions performed by a user via a user device;
detecting that the user has made reservations for at least a subset of a first vacation at a first vacation location;
based at least in part on the tracking and detecting, extracting attractions and events related to the first vacation location;
monitoring conditions at the first vacation location and at the extracted attractions and events;
notifying the user of any conditions that may negatively impact the first vacation; and
in response to a request from the user, offering an alternative vacation to the user with attractions and events that are similar to the extracted attractions and events, the alternate vacation at an alternate vacation location different than the first vacation location.

19. The computer program product of claim 18, wherein the tracking comprises analyzing a search history of the user, a social media interaction of the user, a text conversation of the user, an email interaction of the user, or a voice conversation of the user.

20. The computer program product of claim 18, wherein the user does not have a reservation for at least one of the extracted attractions and events related to the first vacation location.
